(19) United States
(12) Patent Application Publication
(10) Pub. No.: US 2013/0333238 A1
(43) Pub. Date: Dec. 19, 2013

(54) WASTE HEAT RECOVERY AND STORAGE SYSTEM FOR A DISHWASHING APPLIANCE

(71) Applicant: Ramasamy Thiyagarajan, Louisville, KY (US)

(72) Inventor: Ramasamy Thiyagarajan, Louisville, KY (US)

(73) Assignee: GENERAL ELECTRIC COMPANY, Schenectady, NY (US)

(21) Appl. No.: 13/526,880

(22) Filed: Jun. 19, 2012

(51) Int. Cl. A47L 15/02; F26B 3/02; F28D 15/02; A47L 15/42; A47L 15/48

(52) U.S. Cl. 34/476; 134/105; 165/104.21; 165/104.13

(57) ABSTRACT

A dishwashing appliance is provided having features that allow for the recovery, storage, and use of heat energy present in fluids that have been used in a cycle of the appliance such as for washing or rinsing. Before or during the draining of such fluid from the appliance, the heat is captured as latent heat using a heat transfer pipe containing a phase change material. This heat can be transferred to another phase change material and stored as latent heat. The stored heat is then transferred to air or a clean fluid such as e.g., fresh water for use in another cycle of the appliance.

### FIELD OF THE INVENTION

The subject matter of the present disclosure relates generally to the recovery, storage, and use of the heat energy from the waste water of a dishwashing appliance.

### BACKGROUND OF THE INVENTION

Modern dishwashing appliances commonly include a wash chamber where articles such as dishes, cups, cooking utensils and other articles can be placed for cleaning Usually, one or more wash or rinse cycles are used to remove food particles and other debris from the articles. Detergent and one or more additional additives are combined with water to create wash and rinse fluids. These fluids are circulated through the wash chamber and sprayed over the dishes using one or more spray assemblies. The fluid remaining at the end of a wash or rinse cycle is typically pumped and/or drained out of the appliance and into a sewage or waste disposal line.

Wash and/or rinse cycles commonly use a wash or rinse fluid that is heated to improve the efficacy of the cleaning process. The dishwashing appliance may be supplied with hot water and/or the water may be heated after it has been introduced into e.g., the wash chamber of the appliance. By way of example, temperatures of about 140° F. or greater may be used.

Unfortunately, the draining of these heated fluids from the dishwashing appliance represents a significant energy loss. More specifically, because these fluids are typically drained to sewage at the completion of a wash or rinse cycle, none of the heat energy remaining in the fluid is recovered. The use of additional cycles and/or larger amounts of heated fluid for larger or dirtier loads only exacerbates the energy loss.

Challenges are presented in attempting to recover the energy remaining in the heated wash and rinse fluids. Typically, at the end of a cycle, the heated fluid must be drained from the sump portion of the wash chamber. Similarly, at the beginning of a cycle, the sump portion is filled with water to provide the wash or rinse fluid that will be used during the cycle. Accordingly, using a heat exchanger to transfer heat between the used fluid that is being drained and e.g., incoming fresh water is not practical because the sump portion is the only portion of the appliance available for fluid storage. The use of a storage vessel to temporarily store the used fluid or the incoming fresh water and enable heat exchange between the two is impractical because of the space that would be required in the appliance.

Accordingly, a dishwashing appliance with features for recovering heat energy in a wash or rinse fluid would be useful. A dishwashing appliance that can accomplish such recovery without the use necessarily of an additional storage vessel would be beneficial. Such an appliance that can also provide for storing the heat energy and using the same to provide heat in e.g., other cycles of the appliance would be particularly useful.

### BRIEF DESCRIPTION OF THE INVENTION

The present invention relates to a dishwashing appliance having features that allow for the recovery, storage, and use of heat energy present in fluids that have been used in a cycle of the appliance such as for washing or rinsing. Before or during the draining of such fluid from the appliance, the heat is captured as latent heat using a heat transfer pipe containing a phase change material. This heat can be transferred to another phase change material and stored as latent heat. The stored heat is then transferred to air or a clean fluid such as e.g., fresh water for use in another cycle of the appliance. Additional aspects and advantages of the invention will be set forth in part in the following description, or may be apparent from the description, or may be learned through practice of the invention.

In one exemplary embodiment of the present invention, a dishwashing appliance is provided that includes a wash chamber for receipt of articles for washing, a fluid discharge path for the removal of waste fluid from said wash chamber, and a heat storage chamber. A heat storage phase change material is contained in the heat storage chamber. A first heat pipe has a first end in thermal communication with the heat storage chamber and a second end in thermal communication with the fluid discharge path. A first heat pipe phase change material is contained in the first heat pipe and in thermal communication with the heat storage phase change material through the first end of the first heat pipe and in thermal communication with waste fluid in the fluid discharge path through the second end of the first heat pipe.

In another exemplary aspect, the present invention provides a method of operating a dishwashing appliance that includes the steps of transferring heat from a waste fluid used for a wash or rinse cycle of the appliance to a heat pipe phase change material; absorbing heat from the waste fluid as latent heat energy used to change the state of the heat pipe phase change material; releasing heat from the heat pipe phase change material to a heat storage phase change material; and absorbing heat from the heat pipe phase change material as latent heat energy used to change the state of the heat storage phase change material.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of an exemplary embodiment of a dishwasher appliance of the present invention.

FIG. 2 provides a side view of the dishwasher of FIG. 1. A portion of the cabinet is removed to reveal the interior of the dishwasher.

FIG. 3 provides a diagram to illustrate an exemplary method of the present invention.

FIG. 4 is a schematic of an exemplary embodiment of the present invention.

FIGS. 5 and 6 illustrate exemplary heat recovery, storage, and delivery systems of the present invention.

FIG. 7 illustrates an exemplary embodiment of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

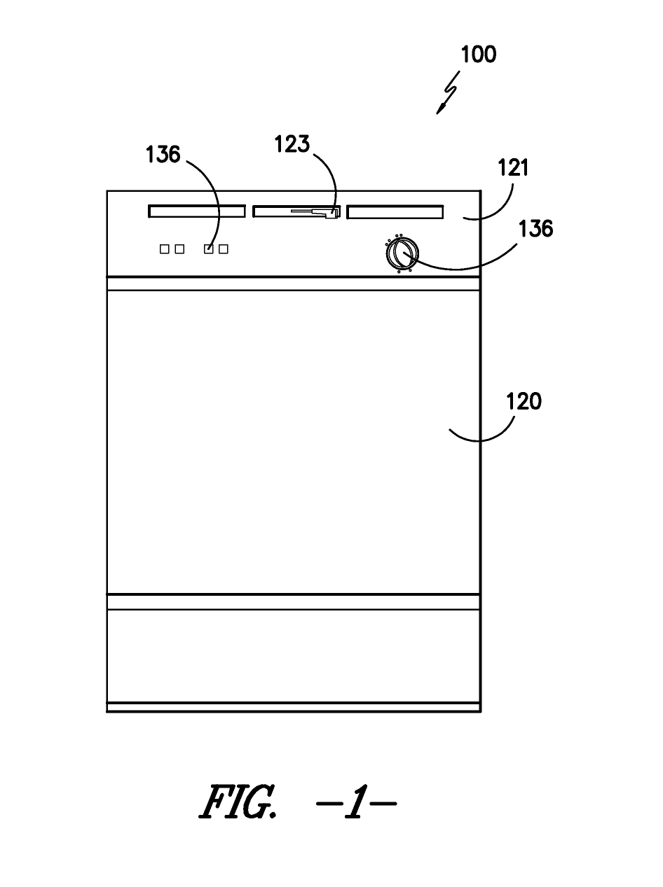

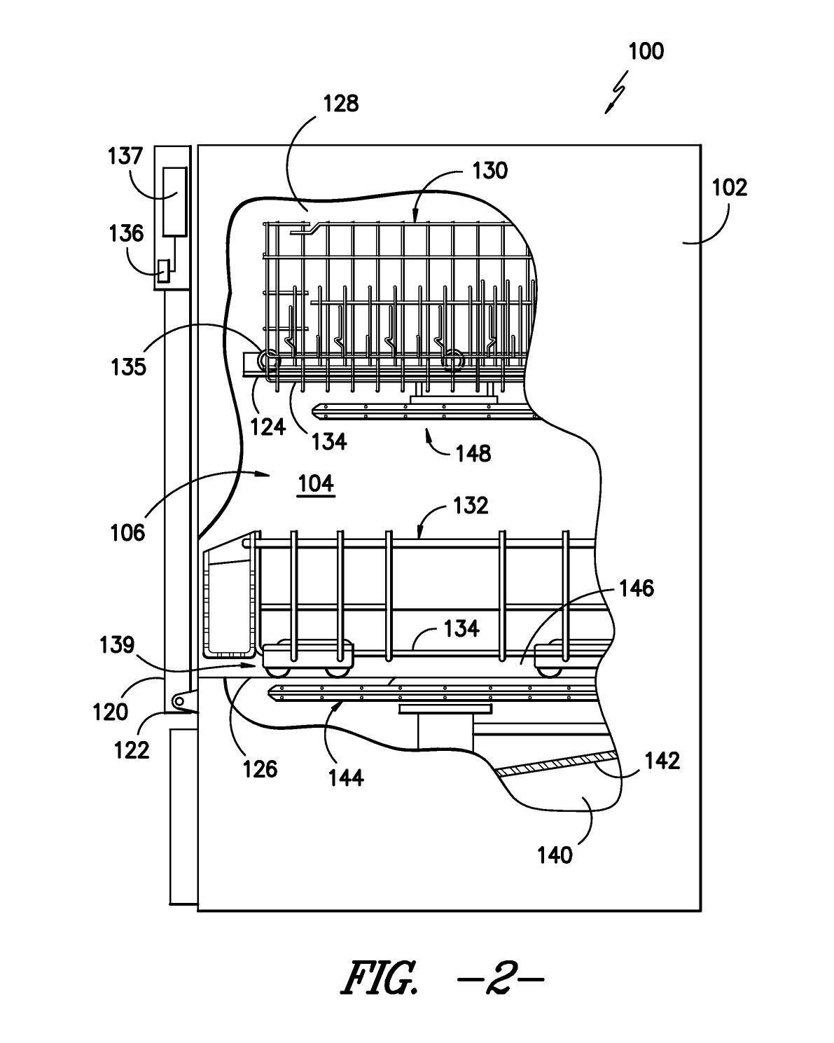

FIGS. 1 and 2 depict an exemplary domestic dishwasher 100 that may be configured in accordance with aspects of the present disclosure. For this particular embodiment, the dishwasher 100 includes a cabinet 102 having a tub 104 therein that defines a wash chamber 106. The tub 104 includes a front opening (not shown) and a door 120 hinged at its bottom 122 for movement between a normally closed vertical position (shown in FIGS. 1 and 2), wherein the wash chamber 106 is sealed shut for washing operation, and a horizontal open position for loading and unloading of articles from the dishwasher. Latch 123 is used to lock and unlock door 120 for access to chamber 106.

Upper and lower guide rails 124, 126 are mounted on tub side walls 128 and accommodate upper and lower roller-equipped rack assemblies 130, 132, respectively. Each of the upper and lower racks 130, 132 is fabricated into lattice structures including a plurality of elongated members 134. Each rack 130, 132 is adapted for movement between an extended loading position (not shown) in which the rack is substantially positioned outside the wash chamber 106 and a retracted position (shown in FIGS. 1 and 2) in which the rack is located inside the wash chamber 106. This is facilitated by rollers 135 and 139, for example, mounted onto racks 130 and 132, respectively. A silverware basket (not shown) may be removably attached to the lower rack 132 for placement of silverware, utensils, and the like, that are too small to be accommodated by the upper and lower racks 130, 132.

The dishwasher 100 further includes a lower spray-arm assembly 144 that is rotatably mounted within a lower region 146 of the wash chamber 106 and above a tub sump portion 142 so as to rotate in relatively close proximity to the lower rack 132. A mid-level spray-arm assembly 148 is located in an upper region of the wash chamber 106 and may be located in close proximity to upper rack 130. Additionally, an upper spray arm assembly (not shown) may be located above the upper rack 130.

The lower and mid-level spray-arm assemblies 144, 148 and the upper spray arm assembly are fed by a fluid circulation assembly for circulating water and dishwasher fluid in the tub 104. The fluid circulation assembly may be located in a machinery compartment 140 located below the bottom sump portion 142 of the tub 104, as generally recognized in the art. Each spray-arm assembly includes an arrangement of discharge ports or orifices for directing washing liquid onto dishes or other articles located in the upper and lower racks 130, 132, respectively. The arrangement of the discharge ports in at least the lower spray-arm assembly 144 provides a rotational force by virtue of washing fluid flowing through the discharge ports. The resultant rotation of the lower spray-arm assembly 144 provides coverage of dishes and other dishwasher contents with a washing spray.

The dishwasher 100 is further equipped with a controller 137 to regulate operation of the dishwasher 100. The controller may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher 100. In the illustrated embodiment, the controller 137 may be located within a control panel area 121 of door 120 as shown. In such an embodiment, input/output (“I/O”) signals may be routed between the control system and various operational components of dishwasher 100 along wiring harnesses that may be routed through the bottom 122 of door 120. Typically, the controller 137 includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

It should be appreciated that the invention is not limited to any particular style, model, or other configuration of dishwasher and that the embodiment depicted in FIGS. 1 and 2 is for illustrative purposes only. For example, instead of the racks 130, 132 depicted in FIG. 2, the dishwasher 100 may be of a known configuration that utilizes drawers that pull out from the cabinet and are accessible from the top for loading and unloading of articles. Other configurations may be used as well.

After a wash or rinse cycle is completed, a waste fluid (i.e. a fluid already used during a cycle of the appliance such that it may contain food particles or other unwanted materials) will be left in tub sump portion 142. Depending upon the parameters of the cycle, this fluid may contain a significant amount of heat energy. However, the waste fluid must be removed from the tub sump portion 142 in preparation for the next cycle of the appliance. A drain pump (not shown) is provided that receives fluid from the tub sump portion 142 and pumps the water fluid along a fluid discharge path in the appliance and then into a sewage line or the like for disposal.

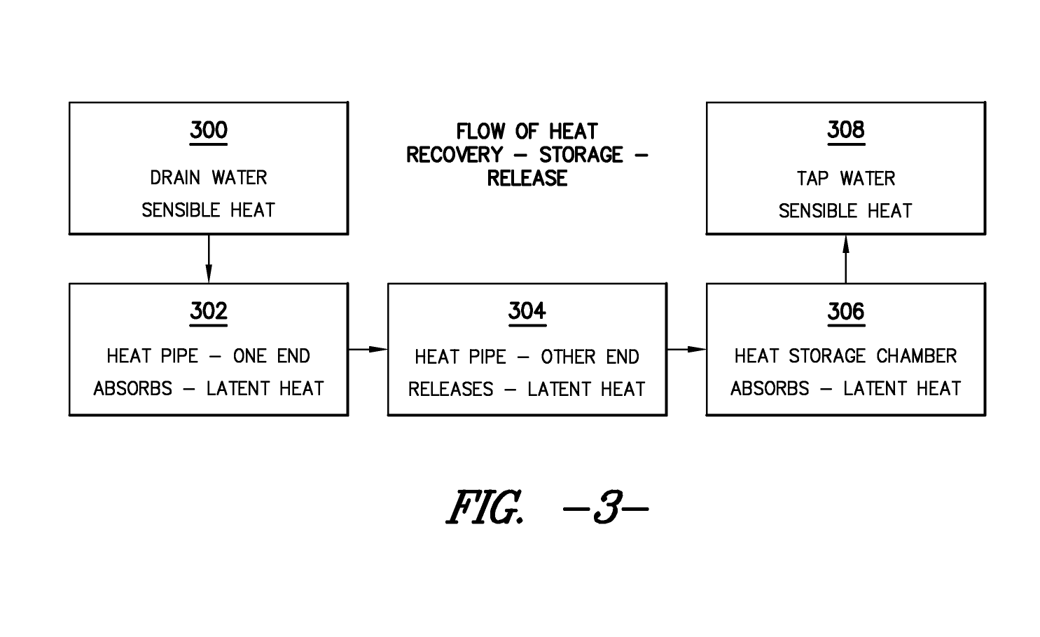

FIG. 3 illustrates an exemplary method of the present invention for recovering heat energy from the waste water. In step 300, the controller operates a pump, valve, and/or other features to drain waste fluid from dishwasher 102. As used herein, “waste fluid” refers to a fluid used for a wash or rinse cycle of the appliance that was heated (relevant to ambient conditions) by the appliance and/or supplied to the appliance as heated. As such, the waste fluid contains heat energy that can be recovered and used. The waste fluid may be e.g., a combination of water with various detergents and other additives, food particles, and/or other materials captured during a wash or rinse cycle.

In step 302, a heat pipe containing a phase change material in vacuum is used to capture sensible heat from the drain water. As used herein, a phase change material or PCM refers to a material that is capable of storing a relatively large amount of energy when it changes phase between e.g., a gas and liquid or between a liquid and a solid. During the phase change, the material either absorbs or releases latent heat energy at a relatively constant temperature as the phase change occurs. By way of example, for a heat pipe of the present invention, PCMs that may be used include dichlorodifluromethane, trichlorofluromethane, benzene, methanol, ammonia, water, mercury, and mixtures thereof. Other materials may be used as well. As these PCMs convert e.g., between a gas and a liquid, they release a latent heat of condensation. Conversely, as these materials convert between a liquid and a gas, they absorb a latent heat of vaporization, which can be temporarily stored. Along with the selection of the PCM, the pressure inside the heat pipe containing the PCM can also be used to select or tune the temperature at which the PCM will absorb or release latent heat associated with a phase change. This pressure can be determined e.g., as the PCM is encapsulated when the heat pipe is manufactured.

Accordingly, using waste fluid drained from dishwasher 102, in step 302 sensible heat is transferred from the waste fluid to a PCM in a heat pipe (i.e. a heat pipe PCM) where is absorbed as latent heat associated with a phase change. This heat transfer can occur along one end of the heat pipe.

At the other end of the heat pipe, the latent heat energy is released in step 304 as the heat pipe PCM changes phase again. In step 306, the latent heat released from the heat pipe PCM is absorbed as latent heat by another PCM (i.e. a heat storage PCM) contained in a heat storage chamber. For example, the heat storage PCM material may be a mixture of sodium silicate and water that absorbs or releases heat as a result of a phase change between a solid and a liquid. Trimethylolethane, dodecanoic acid, and other materials may be used as well. By way of example, the heat storage PCM may change state between a liquid and solid at a temperature in the range of about 100° F. to about 160° F.

In step 308, latent heat is transferred from the heat storage PCM to a fresh fluid for use in dishwasher 102. As used herein, “fresh fluid” can include clean tap water or a mixture of water with detergent or other additives that is to be used in the wash chamber 106 for another cycle of dishwasher 102. The latent heat from the heat storage PCM is absorbed as sensible heat by the fresh fluid so as to increase its temperature for use in e.g., a wash or rinse cycle of the appliance. For example, the fresh fluid may be water and its temperature may be increased by at least about 5° F.

In an alternative embodiment, step 308 could also be used to transfer heat to a gas such as air that is to be circulated in or through wash chamber 106 as part of a drying cycle. Heating the gas will increase its drying efficacy. For example, the gas could be air and its temperature may be increased by at least about 5° F.

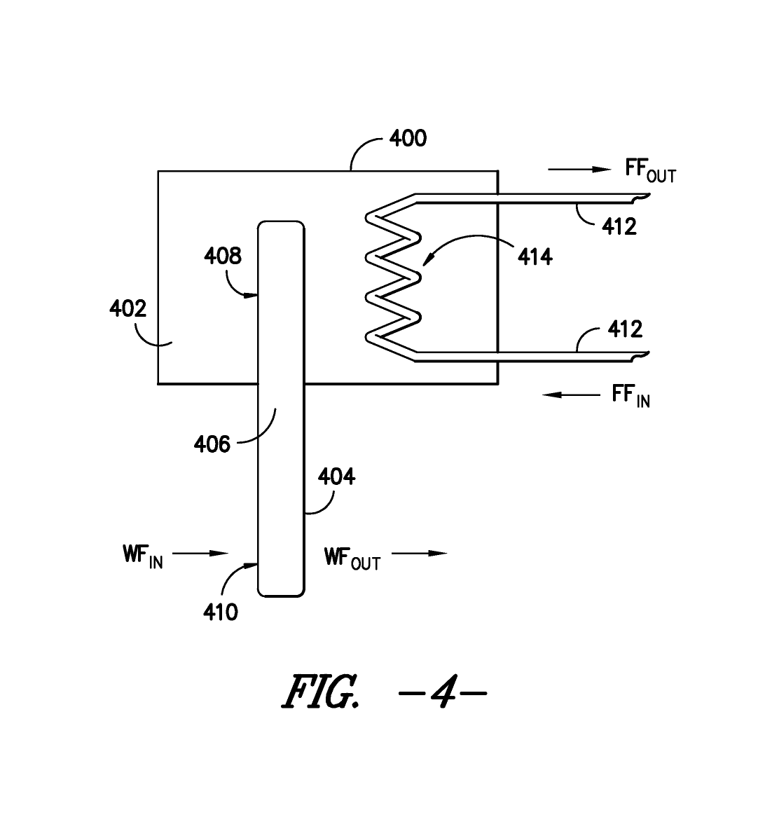

FIG. 4 provides a schematic view of an exemplary embodiment of the present invention as may be used with the exemplary method of FIG. 3. A heat storage chamber 400 contains a heat storage PCM 402. A heat pipe 404 contains a heat pipe PCM 406. Heat pipe PCM 406 has a first end 408 and a second end 410. The second end 410 of heat pipe PCM 406 is in thermal communication with a waste fluid that is flowing past second end 410 as shown by arrows WF_{IN}. First end 408 is contained in heat storage chamber 400 and is in thermal communication with heat storage PCM 402. Fins or other features may be added to heat pipe 404 to increase the surface area available for heat transfer.

A fresh fluid supply path 412 provides for the flow of fresh fluid from a supply (FF_{IN}) and to the wash chamber 106 (FF_{OUT}). As indicated by arrows FF, the fresh fluid flows along fluid inlet path 412, which has a portion inside heat storage chamber 400 where is it is in thermal communication with heat storage PCM 402. Coils 414 or other features may be used to increase the surface area available for heat transfer.

Accordingly, in a manner similar to that described above with regard to FIG. 3, sensible heat from waste fluid flow WF is transferred to second end 410 of heat pipe 404 where it is absorbed as latent heat associated with a phase change by heat pipe PCM 406. Once the waste fluid has been drained from tub sump portion 142 of dishwasher 100, fresh fluid flow FF can be initiated so as to provide thermal communication between the fresh fluid and the heat storage PCM 402.

Using heat pipe PCM 406, heat pipe 404 transfers heat from heat pipe PCM 406 to heat storage PCM 402 through first end 408. More specifically, the latent heat of a phase change associated with heat pipe PCM 406 is transferred to heat storage PCM 402 at the first end 408 of heat pipe 404. This heat is absorbed as latent heat associated with a phase change of heat storage PCM 402.

In turn, latent heat from heat storage PCM 402 is released and absorbed by fresh fluid flow FF as sensible heat that increases the temperature of the fresh fluid. In an alternative embodiment, fresh fluid flow FF may be a flow of air that is heated and supplied to wash chamber 106 to help dry articles contained therein.

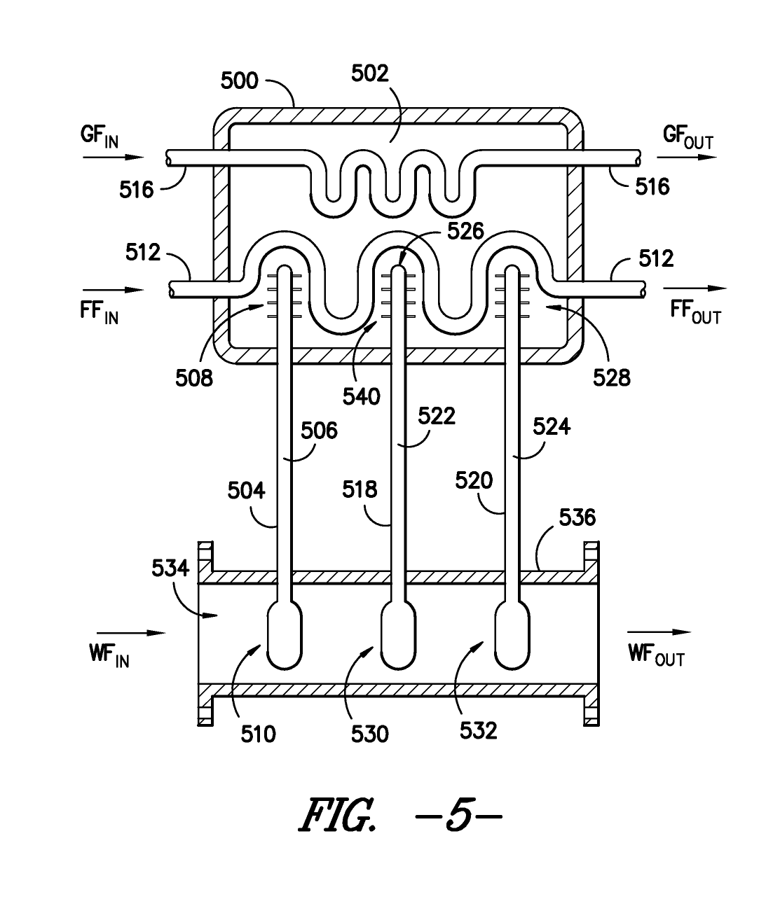

FIG. 5 provides another exemplary embodiment of the present invention. A heat storage chamber 500 contains a heat storage PCM 502. A fresh fluid supply path 512 provides for a flow of fresh fluid FF through chamber 500 in thermal communication with heat storage PCM 502. Additionally and optionally, a gas flow path 516 provides for a flow of air or other gases through chamber 500 in thermal communication with heat storage PCM 502. Accordingly, either a fluid or gas can be heated using heat storage PCM as previously described.

In a manner different than the exemplary embodiment of FIG. 4, the embodiment of FIG. 5 includes three heat pipes 504, 518, and 520. Each heat pipe contains a heat pipe PCM 506, 522, and 524, respectively. First ends 508, 526, and 528 of the heat pipes can be equipped with fins 540 or other features to increase the surface area available for heat transfer.

Seconds ends 510, 530, and 532 of the heat pipes are contained within a fluid discharge path 534 created by conduit 536. For example, conduit 536 might be connected with a pump that drains tub sump portion 142. As such, second ends 510, 530, and 532 are in thermal communication with a flow of waste fluid WF along fluid discharge path 534.

The operation of the exemplary embodiment of FIG. 5 is similar to that described with regard to FIGS. 3 and 4. However, the use of multiple heat pipes 504, 518, and 520 allows for the use of heat pipe PCMs 506, 522, and 524 having different temperatures at which each releases or absorbs latent heat. For example, heat pipe PCM 522 may change state between a liquid and a gas at higher temperature than the temperature at which heat pipe PCM 506 undergoes a similar change of state. Similarly, heat pipe PCM 524 may change state between a liquid and a gas at higher temperature than the temperature at which heat pipe PCM 522 undergoes a similar change of state. As stated previously, through selection of the heat pipe PCMs and/or selection of the pressure at which the PCMs are encapsulated within the heat pipes, the temperatures at which each pipe releases or absorbs latent heat associated with a phase change may be selected.

This use of multiple heat pipes allows for flexibility as to the waste fluid temperatures from which sensible heat may be recovered and stored. More particularly, the temperature of the waste fluid flow WF in FIG. 5 may vary from cycle to cycle. Accordingly, by using a variety of heat pipes, it can be ensured that at least one heat pipe PCM will be available to absorb latent heat at a temperature sufficiently different from the temperature of the waste fluid to provide for heat transfer.

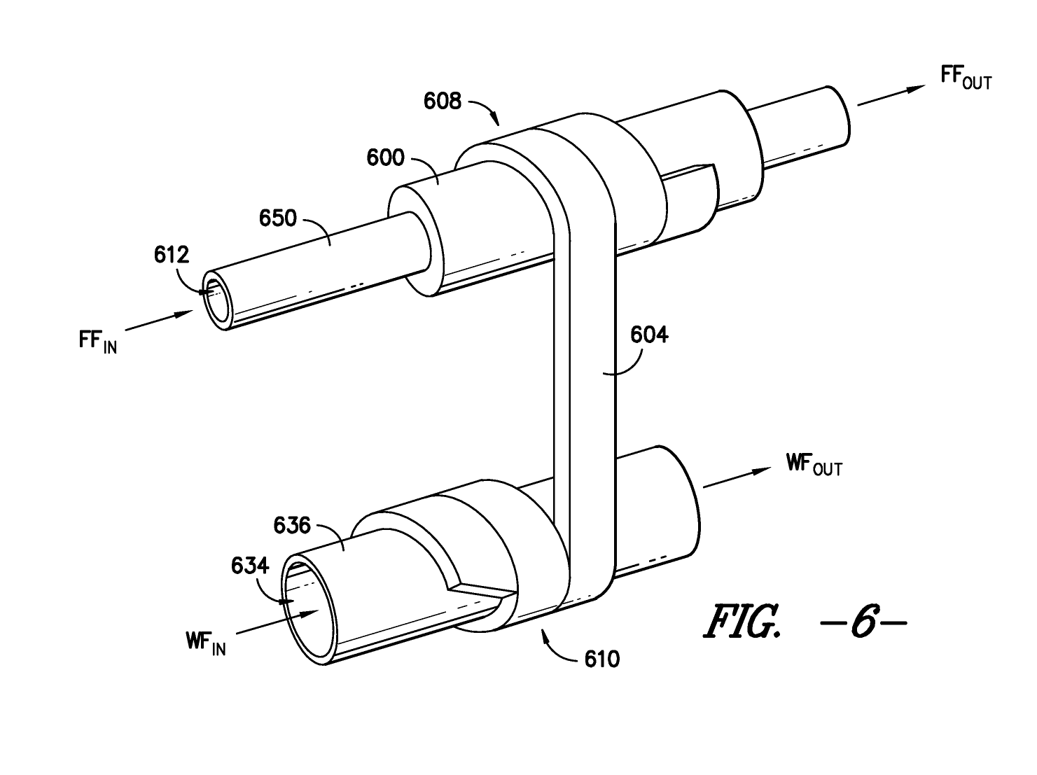

FIG. 6 illustrates another exemplary embodiment of the present invention in which a heat storage chamber 600 encapsulates a heat storage PCM that is in thermal communication with a fresh fluid supply path 612 in conduit 650 that provides fresh fluid to e.g., wash chamber 106. Arrow FF_{IN} represents a flow of fresh fluid to be heated by the latent heat received from the heat storage PCM located in heat storage chamber 600. Arrow FF_{OUT} represents a flow of fresh fluid that has been so heated and will be supplied to e.g., wash chamber 106.

A heat pipe 604 has a first end 608 that is in thermal communication with heat storage chamber 600 and a second end that is in thermal communication with fluid discharge path 634 through conduit 636. More specifically, thermal communication is provided by wrapping first end 608 around chamber 600 and second end 610 around conduit 636. Accordingly, a flow of waste fluid in (WF_{IN}) provides sensible heat that is transferred to a heat pipe PCM located in heat pipe 604. As such, the flow of waste fluid out (WF_{OUT}) is at a lower temperature than the flow of waste fluid in (WF_{IN}). The sensible heat from the waste fluid is absorbed by the heat pipe PCM as a latent heat. This latent heat can then be transferred to the heat storage PCM in heat storage chamber 600 through the first end 608 of heat pipe 604.

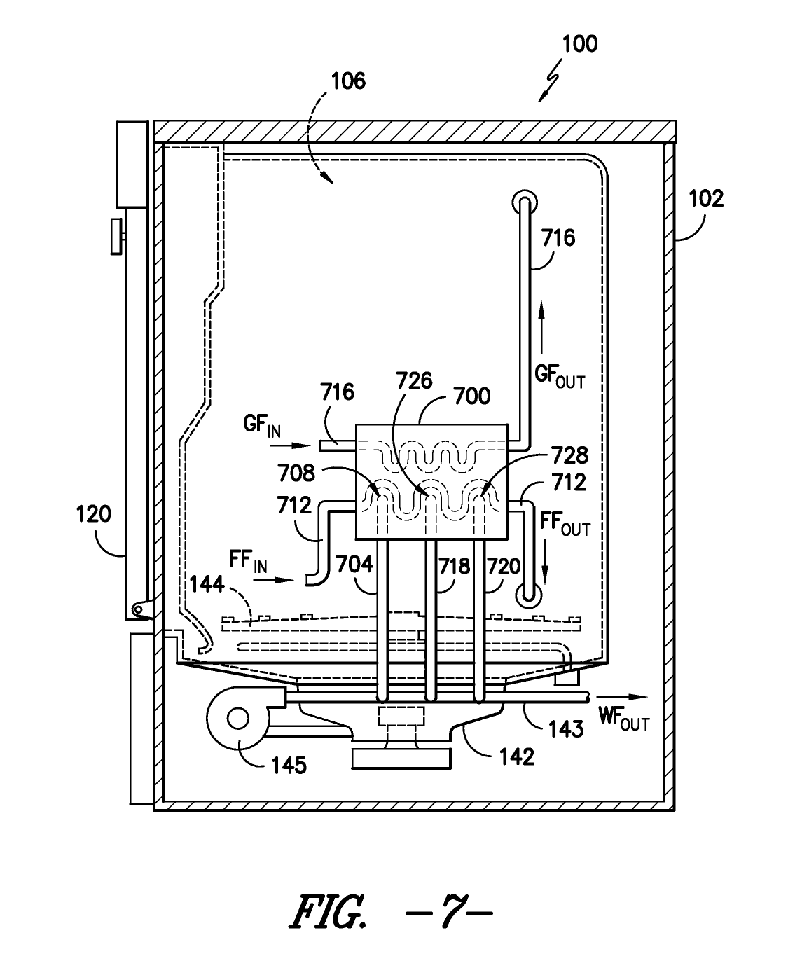

FIG. 7 provides another example of the use of the present invention with the exemplary embodiment of dishwasher 100. A heat storage container 700 contains a heat storage PCM. A gas flow path 716 provides for a flow in of gas (GF_{IN}) to be heated and then supplied (GF_{OUT}) to wash chamber 106 for use in e.g., drying articles in chamber 106. A fresh fluid supply path 712 provides a flow of flow in of a fresh fluid (FF_{IN}) to be heated and then supplied (FF_{OUT}) to wash chamber 106 for use in e.g., washing or rinsing articles in chamber 106.

Heat pipes 704, 718, and 720 have first ends 708, 726, and 728 in thermal communication with heat storage container 700. Second ends (not shown) are in thermal communication with a waste fluid discharge path 143. More specifically, seconds ends of heat pipes 704, 718, and 720 may be immersed directly into waste fluid discharge path 143, may be wrapped around path 143, or may otherwise be placed in contact with path 143 such that heat exchange takes place. In an alternative embodiment, the second ends may be immersed in (or otherwise placed in thermal communication with) tub sump portion 142 to receive heat from a waste fluid at the end of a cycle. Drain pump 145 provides for the removal of waste fluid from tub sump portion 142 and discharge through path 143.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwashing appliance, comprising:
a wash chamber for receipt of articles for washing;
a fluid discharge path for the removal of waste fluid from said wash chamber;
a heat storage chamber;
a heat storage phase change material contained in said heat storage chamber;
a first heat pipe having a first end in thermal communication with said heat storage chamber and a second end in thermal communication with said fluid discharge path; and
a first heat pipe phase change material contained in said first heat pipe and in thermal communication with said heat storage phase change material through the first end of said first heat pipe and in thermal communication with waste fluid in said fluid discharge path through the second end of said first heat pipe.

2. A dishwashing appliance as in claim 1, further comprising:
a fresh fluid supply path for the supply of fresh fluid to said wash chamber;
wherein said fresh fluid supply path is in thermal communication with said heat storage phase change material whereby sensible heat may be provided to fresh fluid in said fresh fluid supply path.

3. A dishwashing appliance as in claim 1, further comprising:
a gas flow path for the supply of heated gas into said wash chamber;
wherein said gas flow path is in thermal communication with said heat storage phase chamber material whereby sensible heat may be provided to gas in said gas flow path.

4. A dishwashing appliance as in claim 1, wherein said heat storage phase change material changes state between a liquid and a solid at a temperature in the range of about 100° F. to about 160° F.

5. A dishwashing appliance as in claim 1, wherein said heat storage phase change material comprises sodium silicate and water.

6. A dishwashing appliance as in claim 1, wherein said first heat pipe phase change material changes state between a liquid and a gas at a temperature in the range of about 100° F. to about 160° F.

7. A dishwashing appliance as in claim 1, wherein said first heat pipe phase change material is selected from the group consisting of dichlorodifluromethane, trichlorofluromethane, benzene, methanol, ammonia, water, mercury, and mixtures thereof

8. A dishwashing appliance as in claim 1, further comprising:
a second heat pipe having a first end in thermal communication with said heat storage chamber; and
a second heat pipe phase change material contained in said second heat pipe and in thermal communication with said heat storage phase change material through the first end of said second heat pipe;
wherein said second heat pipe phase change material changes state between a liquid and a gas at a higher temperature than the temperature at which the first phase change material changes state between a liquid and a gas.

9. A dishwashing appliance as in claim 8, further comprising:
a third heat pipe having a first end in thermal communication with said heat storage chamber; and
a third heat pipe phase change material contained in said third heat pipe and in thermal communication with said heat storage phase change material through the first end of said third heat pipe;
wherein said third heat pipe phase change material changes state between a liquid and a gas at a higher temperature than the temperature at which the second phase change material changes state between a liquid and a gas.

10. A method of operating a dishwashing appliance, comprising:
transferring heat from a waste fluid used for a wash or rinse cycle of the appliance to a heat pipe phase change material;
absorbing heat from the waste fluid as latent heat energy used to change the state of the heat pipe phase change material;
releasing heat from the heat pipe phase change material to a heat storage phase change material; and
absorbing heat from the heat pipe phase change material as latent heat energy used to change the state of the heat storage phase change material.

11. A method of operating a dishwashing appliance as in claim 10, further comprising the steps of:
transferring heat between the heat storage phase change material and a fresh fluid for supply into the wash chamber; and
increasing the temperature of the fresh fluid.

12. A method of operating a dishwashing appliance as in claim 11, wherein the fresh fluid comprises water and said step of increasing raises the temperature of the water by at least about 5° F.

13. A method of operating a dishwashing appliance as in claim 10, further comprising the steps of:
transferring heat between the heat storage phase change material and a gas for supply into the wash chamber; and
increasing the temperature of the gas.

14. A method of operating a dishwashing appliance as in claim 13, wherein the gas comprises air used for drying articles in the wash chamber and said step of increasing raises the temperature of the air by at least about 5° F.

15. A method of operating a dishwashing appliance as in claim 10, wherein the heat storage phase change material changes state between a liquid and a solid at a temperature in the range of about 100° F. to about 160° F.

16. A method of operating a dishwashing appliance as in claim 10, wherein the heat storage phase change material comprises sodium silicate and water.

17. A method of operating a dishwashing appliance as in claim 10, wherein the heat pipe phase change material changes state between a liquid and a gas at a temperature in the range of about 100° F. to about 160° F.

18. A method of operating a dishwashing appliance as in claim 10, wherein the heat pipe phase change material is selected from the group consisting of dichlorodifluromethane, trichlorofluromethane, benzene, methanol, ammonia, water, and mercury.
